(19) United States
(12) Patent Application Publication
(10) Pub. No.: US 2012/0328147 A1
(43) Pub. Date: Dec. 27, 2012

(54) SPEAKER

(75) Inventors: Suk-Joo Kim, Seoul (KR); Dong-Chol Heo, Incheon (KR)

(73) Assignee: ASEN LAB CO., LTD, Incheon (KR)

(21) Appl. No.: 13/582,605

(22) PCT Filed: Mar. 8, 2011
(86) PCT No.: PCT/KR2011/001573

§ 371 Date: Sep. 4, 2012

(30) Foreign Application Priority Data
Mar. 9, 2010 (KR) 10-2010-0020889
Mar. 3, 2011 (KR) 10-2011-0019102

(51) Int. Cl. H04R 3/00; H04R 9/06

(52) U.S. Cl. 381/400; 381/412

(57) ABSTRACT

A speaker is disclosed herein. And, in configuring a magnetic circuit of the speaker, unlike the vertical polarity alignment of the related art speaker, the polarities of the magnet are configured to be horizontally aligned, and a vibration system is configured on an inner side surface of the vertically configured magnetic circuit. Accordingly, by having the magnetic circuit encircle the vibration system, unlike in the related art speaker, wherein the height of the speaker corresponds to a sum of the thickness of the vibration system and the thickness of the magnetic circuit, the speaker may be configured only by using the height of the magnetic circuit. Furthermore, by being capable of reducing the height of the speaker, even if the volume of the magnet is being increased, the sound effect of the speaker may be enhanced.

### FIELD OF THE INVENTION

The present invention relates to a speaker and, more particularly, to a speaker having a remarkably low height and showing excellent performance.

### BACKGROUND ART

Generally, a speaker refers to a device that converts electrical signals to sound that can be heard through our ears. Meanwhile, among diverse speakers, a micro speaker refers to a speaker that is suitable for being mounted on small-sized electrical devices or mobile communication devices.

Recently, the electrical devices are becoming smaller in size and more light-weight. Accordingly, the speakers being applied to the electrical devices are required to be even smaller in size and lighter in weight and to show more excellent performance.

FIG. 1 and FIG. 2 illustrate cross-sectional views showing a related art single magnet speaker. As shown in FIG. 1, in the related art speaker, a frame (111) configures an outside form of the speaker (120). A yoke (104), which is configured to provide a flow path for a magnetic flux generated from a magnet (101), is provided inside the frame (111). The yoke (104) comprises a bottom plate (102) having a cylindrical shape with a closed bottom surface and a plate (103) having a circular plane. circular magnet (101) is placed between the bottom plate (102) and the top plate (103). Meanwhile, a magnetic flux, which is generated by the magnet (101), is guided to the yoke (104) and then meets a gap of the yoke (104), which is also referred to as a magnetic gap.

As shown in FIG. 2, the magnet (101), the yoke (104), and the magnetic gap configure a magnetic circuit. Herein, a magnetic circuit refers to a device providing a magnetic field, which allows the speaker to convert the electrical signals to sound.

Meanwhile, a voice coil (105) is placed in the magnetic gap. Herein, the voice coil (105) is connected to a diaphragm (106). When the voice coil (105) performs vertical movements in accordance with the supplied electrical signals, such movements are delivered to the diaphragm (106), which then vibrate the diaphragm (106), thereby converting the electrical signals to sound. As shown in FIG. 1, the diaphragm (106) is configured to have a dome-shape at the central portion and a ribbed-shape at the edge portion. Herein, the voice coil (105) is connected to the diaphragm (106) at a boundary region between two dome-shaped figures. The diaphragm (106) is configured to have a double dome structure in order to be capable of controlling the vibration range while facilitating the vibration of the diaphragm.

A lead wire (107) is connected to the voice coil (105), so as to supply the electrical signals. The lead wire (103) is generally adhered along the surface of the diaphragm (106) and then passes through a hole formed. in the frame (111), so as to be connected to a terminal PCB (108).

As shown in FIG. 2, the diaphragm (106) and the voice coil (105) configures a vibration system (132).

A vent hole cap (109) covers the diaphragm (106). The vent hole cap (109) is used to protect other devices located inside of the speaker, including the diaphragm (106). Additionally, in order to allow the sound, which is generated by the diaphragm (106), to be easily delivered outside of the speaker, a plurality of vent holes (110) is formed in the vent hole cap (109). Meanwhile, a plurality of heat discharge openings (112) is formed. in the frame (111), so as to discharge the heat being generated inside the speaker to the outside.

The related art speaker performs the following operations. When an electrical, signal is supplied to the voice coil (105) through the terminal PCB (108) and the lead wire (107), according to the Fleming's rule, the voice coil (105) located in the magnetic gap performs vertical movements perpendicular to the magnetic field, and such movements are delivered to the diaphragm (106). The movements that are delivered to diaphragm (106) vibrate the diaphragm (106), thereby converting the electrical signal to sound.

The related art speaker shown in FIG. 1 and FIG. 2 has the following disadvantages. In the related art speaker, since the magnetic circuit (131) and the vibration system (132) form vertical layers, the height of the speaker increases. More specifically, the total height of the speaker is decided by adding the thickness of the magnetic circuit and the thickness of the vibration system.

Therefore, in order to decrease the thickness of the speaker, it is inevitable to reduce the thickness of the magnet (101). However, once the thickness of the magnet (101) is reduced, the magnetic flux density within the magnetic gab decreases accordingly, thereby causing a decrease in a sound pressure of the speaker.

Furthermore, due to the thickness of the speaker (120), the speaker is assembled while being detached from an electronic module PCB substrate, thereby causing the efficiency in the fabrication process to be decreased. Moreover, due to a large number of assembly parts, the assembly time is extended, which eventually causes an increase in the overall fabrication cost.

FIG. 3 illustrates a cross-sectional view of a related art double magnet speaker. The speaker shown in FIG. 3 is provided with first magnet (141) having a circular shape and placed in the central area, and a second magnet (142) having a ring shape and sharing the same center point as the first magnet (141).

Herein, the first magnet (141) and the second magnet (142) are provided on a single bottom plate (143). Meanwhile, the first magnet (141) is covered by a first top plate (144), and the second magnet (141) is covered by a second top plate (145). And, a magnetic gap is formed between the first top plate (144) and the second top plate (145). Additionally, the bottom plate (143), the first top plate (144), and the second top plate (145) configure a yoke (146), which provides a flow path of the magnetic flux.

In the double magnet speaker shown in FIG. 3, since the magnetic circuit and the vibration system also collectively form a layer, in order to reduce the overall height of the speaker, it is inevitable to reduce the thickness of the first magnet (141) and the thickness of the second magnet (142). Accordingly, as described above in the single magnet speaker, the double magnet speaker is disadvantageous in that the sound pressure may be decreased, and in that the fabrication cost may be increased due to the complex structure of the speaker.

FIG. 4 illustrates a cross-sectional view of a related art speaker being applied to a navigation system and a mobile gaming device. The speaker shown in FIG. 4 has the same structure as the speaker shown in FIG. 1. However, in order to increase productivity, a bottom plate (151) is used as the frame. Furthermore, the speaker shown in FIG. 4 is configured to have a thin vibration system in order to reduce the overall thickness of the speaker.

However, in the speaker shown in FIG. 4, since the voice coil (152) is significantly deviated from the magnetic field, a loss in the frequency band may occur. More specifically, the speaker shown in FIG. 4 is disadvantageous in that a minimum threshold frequency (f0) increases.

Additionally, in order to perform high output, a thick voice coil (152) is required to be used. However, since the diameter of the voice coil (152) is small, the winding width increases, and when the voice coil (152) performs the vertical movements, due to the X—MAX value (vertical movement range of the coil when performing a rated output:mm), the height of the magnetic circuit may increase. Furthermore, due to a decrease in the magnetic force of the magnetic circuit, a lack of clarity and resolution in the voice tone and a decrease in the sound pressure may occur.

FIG. 5 illustrates a cross-sectional view showing related art inner type and outer type magnetic circuits. FIG. 5 (a) corresponds to a cross-sectional view showing a structure of a related art inner type magnetic circuit, and FIG. 5 (b) corresponds to a cross-sectional view showing a structure of a related art outer type magnetic circuit.

Referring to FIG. 5 (a), since the magnet (161) is located on an inner surface of the yoke (164), FIG. 5 (a) is referred to as a inner type magnetic circuit. Herein, the yoke (164) comprises a bottom plate (162) and a top plate (163), and the direction of the arrow indicates a flow path of the magnetic flux, which is generated by the magnet (161).

Referring to FIG. 5 (b), since the magnet (171) is located on an outer surface of a pole piece (175), which is connected to the bottom plate (172), FIG. 5 (b) is referred to as an outer type magnetic circuit. The direction of the arrow shown in FIG. 5 (b) indicates a flow path of the magnetic flux, which is generated. by the magnet (71).

As described above, in the related art speaker, a magnetic circuit is configured by laminating a bottom plate, a magnet, and a top plate. And, by configuring a vibration system above the magnetic circuit, the height of the speaker may increase.

### DETAILED DESCRIPTION OF THE INVENTION

### Technical Objects

An object of the present invention is to provide a speaker having an enhanced sound and a remarkably reduced eight that can obviate the above-described technical problems of the related art speaker.

### Technical Solutions

In order to achieve the above-described technical objects of the present invention, when configuring the magnetic speaker according to the present invention, instead of performing a vertical polarity alignment of the related art, the polarity of the magnets should be aligned and configured along a horizontal direction, and a vibration system should be provided inside the magnetic circuit, which is configured along the horizontal direction.

### Advantageous Effects

A micro speaker according to the present invention has the following advantages.

First of all, by increasing the magnetic force, the present invention may provide a high sound pressure output.

Secondly, by decreasing the height of the speaker to a maximum level, the size of the electronic device having the speaker mounted thereon may also be reduced.

Thirdly, by using a voice coil having a larger diameter, a wire thicker than the related art voice coil may be used. Thus, a high input high output speaker may be fabricated.

Fourthly, with a decrease in the number of assembly parts, the assembly process of the micro speaker is more simplified. Accordingly, the micro speaker may be fabricated by means of automated production, thereby reducing the fabrication cost.

Fifthly, since a vent hole unit is formed on a lower surface, heat being generated from the voice coil may immediately discharged, thereby enhancing the durability of the speaker.

Seventhly, by increasing the sound pressure and by using a strong diaphragm, the f0 may be lowered.

Finally, since the speaker may be assembled along with an electronic PCB module of a compact mobile device manufacturer, the productivity may also be enhanced.

### BRIEF DESCRIPTION OF THE DRAWINGS

FIG. 1 and FIG. 2 illustrate cross-sectional views showing a related art single magnet speaker.

FIG. 3 illustrates a cross-sectional view of a related art double magnet speaker.

FIG. 4 illustrates a cross-sectional view of a related art speaker being applied to a navigation system and a mobile gaming device.

FIG. 5 illustrates a cross-sectional view showing related art inner type and outer type magnetic circuits.

FIG. 6 illustrates a cross-sectional view of a magnetic circuit included in a speaker according to an exemplary embodiment of the present invention.

FIG. 7 illustrates a cross-sectional view of a speaker according to a first embodiment of the present invention.

FIG. 8 illustrates a cross-sectional view of a speaker according to a second embodiment of the present invention.

FIG. 9 illustrates a cross-sectional view of a speaker according to a third embodiment of the present invention.

FIG. 10 illustrates a dispersed perspective view of a speaker according to the first embodiment of the present invention.

FIG. 11 illustrates a dispersed perspective view of a speaker according to the third embodiment of the present invention.

FIG. 12 illustrates a graph comparing a performance of the speaker according to the first embodiment of the present invention with a performance of the related art speaker.

FIG. 13 illustrates a graph comparing a performance of the speaker according to the third embodiment of the present invention with a performance of the related art speaker.

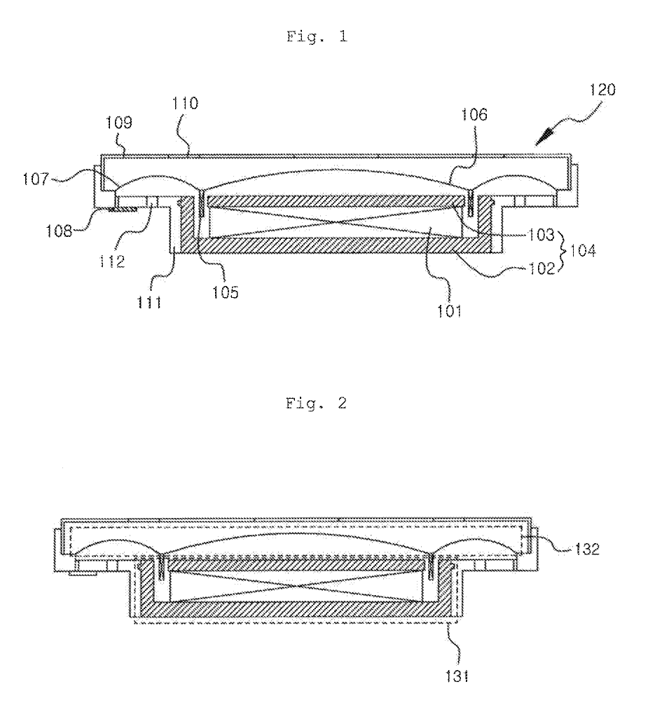

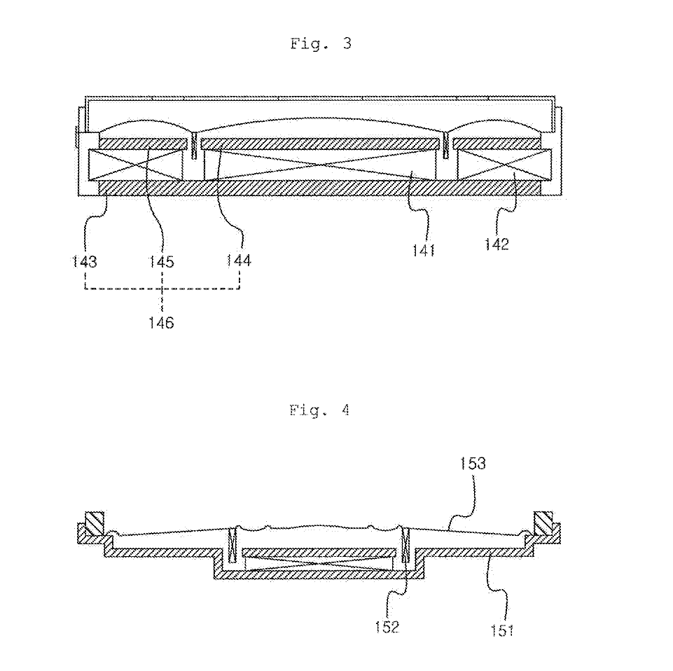

### BEST MODE FOR CARRYING OUT THE PRESENT INVENTION

The speaker according to the present invention includes a magnetic circuit and a vibration system, wherein the magnetic circuit includes a magnetic circuit having a ring structure, having a first polarity on an outer side surface based upon a center point of the ring, and having a second polarity having an inner side surface, the second polarity having a polarity opposite to that of the first clarity, and yoke providing a flow path for a magnetic flux being generated from the magnet.

### MODE FOR CARRYING OUT THE PRESENT INVENTION

The above-described technical objects, characteristics, and advantages of the present invention will be more clarified based upon the following detailed description of the present invention. The preferred embodiments of the present invention will hereinafter be described in more detail with reference to the accompanying drawings.

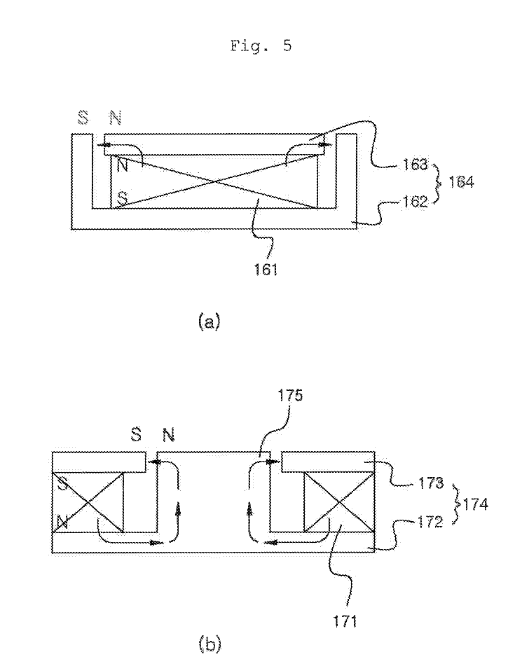

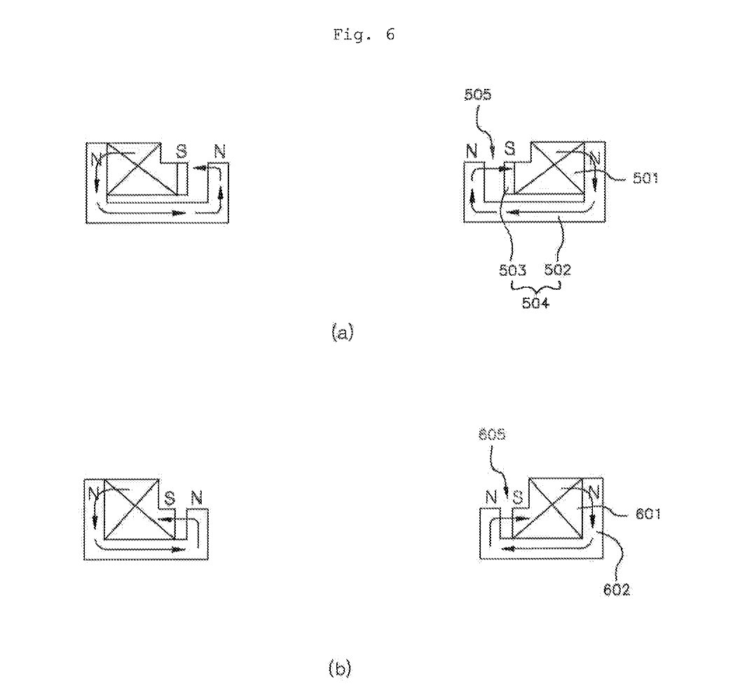

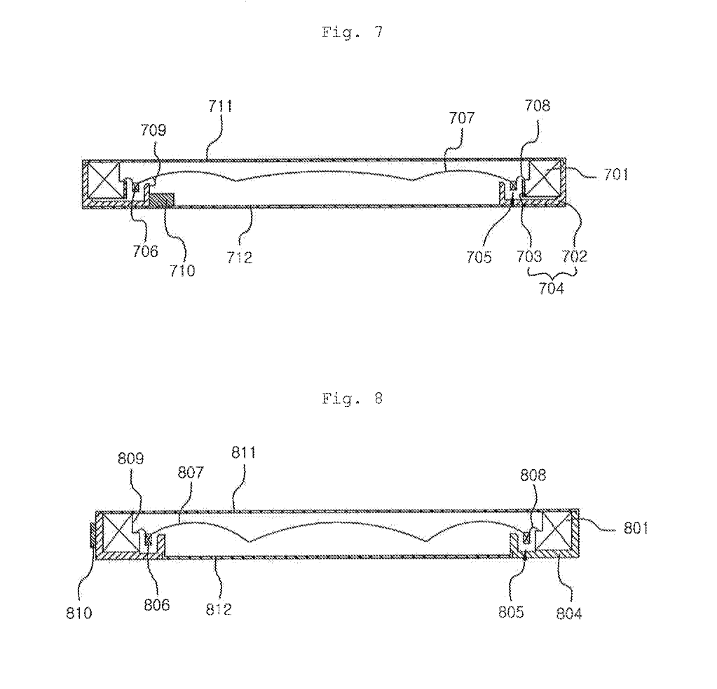

FIG. 6 illustrates a cross-sectional view of a magnetic circuit included in a speaker according to an exemplary embodiment of the present invention. In the magnetic circuit shown in FIG. 6, the N pole and the S pole of the magnet are horizontally aligned. As shown in FIG. 5, in the magnetic circuit of the related art speaker, the N pole and the S pole of the magnet are vertically aligned, and only the magnetic flux is horizontally generated within the magnetic gap. However, in the magnetic circuit according to the present invention, the N pole and the S pole of the magnet are horizontally aligned, and the magnetic flux is also horizontally generated within the magnetic gap.

As a magnetic circuit according to the present invention, FIG. 6(a) illustrates an exemplary embodiment having two plates. Referring to FIG. 6(a), the magnet (501) according to the present invention is configured to have the shape of a ring and to have a step difference starting from the outer surface to the inner surface Additionally, the polarity of the magnet (501) is configured so that the S pole corresponds to the inner surface, and so that the N pole corresponds to the outer surface. More specifically, the N pole and the S pole are horizontally aligned. Meanwhile, it will also be apparent that the polarity of the magnet (501) may also be configured so that the N pole corresponds to the inner surface, and so that the S pole corresponds to the outer surface, and wherein the N pole and the S pole are horizontally aligned.

As shown in FIG. 6(a), when the N pole is located at the outer surface of the magnet. (501), the magnetic flux begins to move from the N pole and sequentially passes through a first plate (502), a magnetic gap (505), and a second plate (503), so as to reach the S pole of the magnet (501). The first plate (502) and the second plate (503) collectively function as a yoke (504), which provides a flow path for the magnetic flux. At this point, the magnetic circuit may be configured so that the magnet (501) can be closely adhered to the first plate (501). However, as shown in FIG. 6(a), the magnetic circuit may also be configured so that the magnet (501) can be spaced apart from the first plate (501) at a predetermined distance.

As a magnetic circuit according to the present invention, FIG. 6(b) illustrates an exemplary embodiment having only one plate. Referring to FIG. 6(b), the magnet (601) according to the present invention is configured to have the shape of a ring and to have a step difference starting from the outer surface to the inner surface. Additionally, the polarity of the magnet (601) is configured so that the S pole corresponds to the inner surface, and so that the N pole corresponds to the outer surface. More specifically, the N pole and the S pole are horizontally aligned. Meanwhile, it will also be apparent that the polarity of the magnet (601) may also be configured so that the N pole corresponds to the inner surface, and so that the S pole corresponds to the outer surface, and wherein the N pole and the S pole are horizontally aligned.

As shown in FIG. 6(b), when the N pole is located at the outer surface of the magnet (601), the magnetic flux begins to move from the N pole and passes through a yoke (602) and a magnetic gap (605), so as to reach the S pole of the magnet (601). Herein, the yoke (602) provides a flow path for the magnetic flux. Herein, the magnetic circuit may be configured so that the magnet (601) can be closely adhered to the yoke (602). However, as shown in FIG. 6(b), the magnetic circuit may also be configured so that the magnet (601) can be spaced apart from the yoke (602) at a predetermined distance.

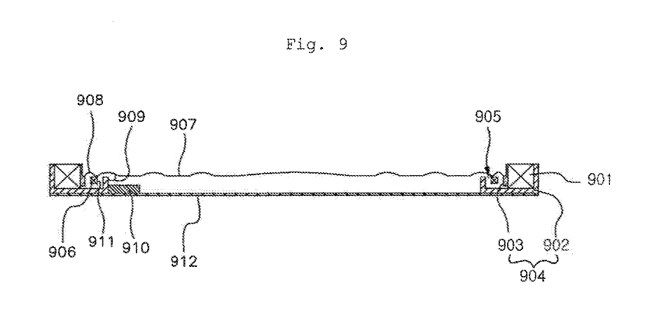

FIG. 7 illustrates a cross-sectional view of a speaker according to a first embodiment of the present invention. This exemplary embodiment of the present invention relates to a speaker adopting the exemplary magnetic circuit described with reference to FIG. 6(a) The magnetic circuit of the speaker according to the first embodiment of the present invention. includes a magnet (701) having the N pole and the S pole horizontally aligned, a first plate (702), a second plate (703), and a magnetic gap (705), which is created between the first plate (702) and the second plate (703).

It is preferable that the magnet (701) is configured in a ring shape having a step difference starting from the outer surface to the inner surface. Herein, in addition to a circular ring shape, the ring shape may also include rectangular rings and elliptical rings.

For example, when the outer surface of the magnet (701) corresponds to the N pole, the magnetic flux being generated from the magnet (701) may start moving from the N pole and may then pass through the first plate (702) and through the magnetic gap (705) and the second plate (703), so as to reach the S pole, which is formed at the inner surface of the magnet (701). Accordingly, the first plate (702) and the second plate (703) collectively perform the function of a yoke (704), which provides a flow path for the magnetic flux.

Meanwhile, a vibration system of the speaker according to the exemplary embodiment of the present invention comprises a voice coil (706), which is located within the magnetic gap (705), and a diaphragm (707). Herein, it is preferable that the voice coil (706) is connected to the diaphragm (707) and an edge part (708). And, it is also preferable that the diaphragm (707) is created to have a double dome structure, wherein a dome is formed at the central portion of the diaphragm (707), and wherein a rib-like dome is formed at the outer boundary of the central dome, so as to encircle the central dome. In addition to a function of supporting the voice coil (706), the edge part (708) also performs a function of facilitating the movement of the diaphragm (707) and controlling the movement of the diaphragm (707), so that the level of vibration does not exceed a predetermined range. In order to receive electrical signals, the voice coil (706) is connected to a lead wire (709), and the lead wire (709) is connected to a terminal PCB (710). An external AMP signal is delivered to the speaker by passing through the terminal PCB (710).

The diaphragm (707) is covered by a vent hole cap (711). The vent hole cap (711) is used to protect other devices located inside of the speaker, including the diaphragm (707). Additionally, in order to allow the sound, which is generated by the diaphragm (707), to be easily delivered outside of the speaker, a plurality of vent holes are formed in the vent hole cap (711). A lower surface unit (712) is attached to a lower surface of the first plate (702). Herein, in addition to a filtering function, which prevents foreign substance from being introduced inside the speaker, the lower surface unit (712) also performs a function of discharging heat generated from the inside of the speaker to the outside.

As described above, in the speaker according to the present invention, since the height of the ring-shaped magnet (or the height of the magnetic circuit) decides the height of the speaker, the present invention may provide a speaker having a remarkably reduced thickness, as compared to the related art speaker. More specifically, according to the related art speaker, since the vibration system is configured on an upper portion of the magnetic circuit, the total thickness of the speaker is equivalent to the sum of the height of the magnetic circuit and the height of the vibration system. However, according to the present invention, since the vibration system is encircled by the magnetic circuit, the thickness of the speaker may be decided by the height of the magnetic circuit. Accordingly, the thickness of the speaker may be reduced in proportion to the height of the magnetic circuit. Furthermore, since the intensity of the magnetic field depends upon the volume of the magnet, and since the magnet configures the outer circumference of the speaker, the volume of the magnet may be maintained while reducing the thickness of the magnet. Thus, the height of the magnetic circuit may also be reduced accordingly.

Additionally, since the yoke performs the function of a frame, which configures the outside feature of the speaker, the a separate frame may be omitted. Thus, the size of the magnetic circuit may be enlarged as much as the size corresponding to the omitted separate frame.

Table 1 shows a comparison between a magnetic flux density being created in the yoke of the related art magnetic circuit and a magnetic flux density being created in the yoke of the speaker according to the first embodiment of the present invention.

TABLE 1

| | Polarity | Maximum Gauss |
|---|---|---|
| Related Art | N pole | 500 |
| | S pole | 1000 |
| Present | N pole | 2200 |
| Invention | S pole | 2500 |

Referring to Table 1, it is apparent that the magnetic circuit according to the first embodiment of the present invention has a magnetic flux density more than 2 times that of the related art magnetic circuit.

In the magnetic circuit of a speaker, when it is given that the mass of a vibration system (weight of the voice coil+weight of the diaphragm) is constant, it is apparent that the speaker according to the present invention may enhance the sound pressure to a higher level, based upon. the intensity of a considerably intense magnetic field.

Table 2 shows a comparison between a performance of the related art speaker and a performance of the speaker according to the first embodiment of the present invention.

TABLE 2

| | Diaphragm | Coil | Impedance | Sound Pressure |
|---|---|---|---|---|
| | Thickness | Thickness | (Ω) | (db) |
| Related | 10 micron | Φ 40 | 7.4 | 90 |
| Art | | micron | | |
| Present | 20 micron | Φ 60 | 6.8 | 96 |
| Invention | | micron | | |

Referring to Table 2, although the difference between the thickness of the diaphragm included in the related art speaker and the thickness of the diaphragm according to the first embodiment of the present invention is equal to 10 micron, it is apparent that there is a significant difference in the sound pressure.

Additionally, since the related art voice coil has a diameter of Φ 40 micron, generally, the related art voice coil cannot yield a high output. However, by using a thicker coil wire, it is apparent that the first embodiment of the present invention can increase the sound pressure to a higher level.

Herein, it is preferable that the size of a magnetic gap is set to be equivalent to a gap between the N pole (or S pole) and a minor diameter, which corresponds to 0.23 mm. And, it is also preferable that the gap between the S pole (or N pole) and a full diameter is also set to 0.23 mm

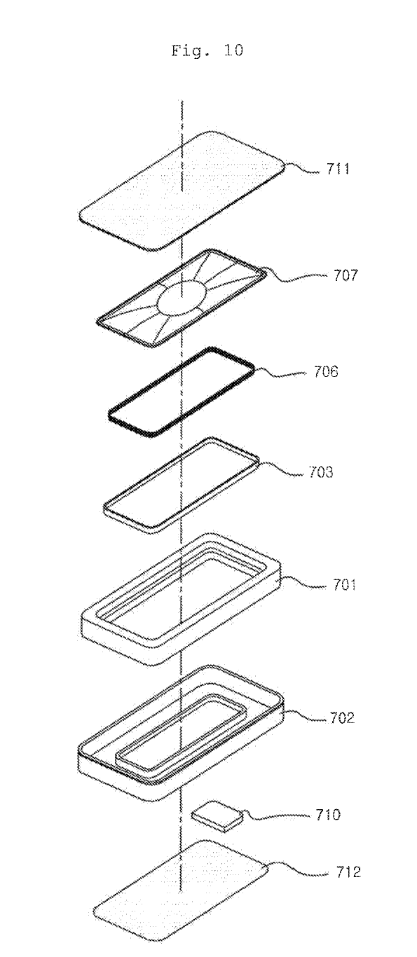

FIG. 8 illustrates a cross-sectional view of a speaker according to a second embodiment of the present invention. This exemplary embodiment of the present invention relates to a speaker adopting the exemplary magnetic circuit described with reference to FIG. 6(b). The magnetic circuit of the speaker according to the first embodiment of the present invention includes a magnet (801) having the N pole and the S pole horizontally aligned, a yoke (804), and a magnetic gap (905), which is created between the yoke (804) and the magnet (801). It is preferable that the magnet (801) is configured in a ring shape having a step difference starting from the outer surface to the inner surface. Herein, in addition to a circular ring shape, the ring shape may also include rectangular rings and elliptical rings.

For example, when the outer surface of the magnet (801) corresponds to the N pole, the magnetic flux being generated from the magnet (801) may start moving from the N pole and may then pass through the yoke (804) and through the magnetic gap (805), so as to reach the S bole, which is formed at the inner surface of the magnet (801). Accordingly, the yoke (804) provides a flow path for the magnetic flux.

Meanwhile, a vibration system of the speaker according to the exemplary embodiment of the present invention comprises a voice coil (806), which is located within the magnetic gap (805), and a diaphragm (807). Herein, it is preferable that the voice coil (806) is connected to the diaphragm (807) and an edge part (808). And, it is also preferable that the diaphragm (807) is created to have a double dome structure, wherein a dome is formed at the central portion of the diaphragm (807), and wherein a rib-like dome is formed at the outer boundary of the central dome, so as to encircle the central dome. In addition to a function of supporting the voice coil (806), the edge part (808) also performs a function of facilitating the movement of the diaphragm (807) and controlling the movement of the diaphragm (807), so that the level of oscillation (or vibration) does not exceed a predetermined range. In order to receive electrical signals, the voice coil (806) is connected to a lead wire (809), and the lead wire (809) is connected to a terminal PCB (810). An external AMP signal is delivered to the speaker by passing through the terminal PCB (810).

The diaphragm (807) is covered by a vent hole cap (811). The vent hole cap (811) is used to protect other devices located inside of the speaker, including the diaphragm (807). Additionally, in order to allow the sound, which is generated by the diaphragm (807), to be easily delivered outside of the speaker, it is preferable that a plurality of vent holes is formed in the vent hole cap (811). A lower surface unit (812) configures the bottom. surface of the speaker along with the yoke (804). Herein, in addition. to a filtering function, which prevents foreign, substance from being introduced inside the speaker, the lower surface unit (812) also performs a function of discharging (or releasing) heat generated from the inside of the speaker to the outside.

FIG. 9 illustrates a cross-sectional view of a speaker according to a third embodiment of the present invention. This exemplary embodiment of the present invention relates to a speaker adopting the exemplary magnetic circuit described with reference to FIG. 6(a).

The magnetic circuit of the speaker according to the first embodiment of the present invention includes a magnet (901) having the N pole and the S pole horizontally aligned, a first plate (902), a second plate (903), and a magnetic gap (905), which is created between the first plate (902) and the second plate (903). It is preferable that the magnet (901) is configured in a ring shape. Herein, in addition to a circular ring shape, the ring shape may also include rectangular rings and elliptical rings.

For example, when the outer surface of the magnet (901) corresponds to the N pole, the magnetic flux being generated from the magnet (901) may start moving from the N pole and may then pass through the first plate (902) and through the magnetic gap (905) and the second plate (903), so as to reach the S pole, which is formed at the inner surface of the magnet (901). Accordingly, the first plate (902) and the second plate (903) collectively perform function of a yoke (904), which provides a flow path for the magnetic flux.

Meanwhile, a vibration system of the speaker according to the exemplary embodiment of the present invention comprises a voice coil (906), which is located within the magnetic gap (905), a bobbin (911), and a diaphragm (907). Herein, the voice coil (906) is wound around the bobbin (911), and the bobbin (911) is connected to the diaphragm (907) and an edge part (908). It is preferable that the diaphragm (907) is formed to have a triple rib structure. In addition to a function of supporting the voice coil (906), the edge part (908) also performs a function of facilitating the movement of the diaphragm (907) and controlling the movement of the diaphragm (907), so that the level of vibration does not exceed a predetermined range. In order to receive electrical signals, the voice coil (906) is connected to a lead wire (909), and the lead wire (909) is connected to a terminal PCB (910). An external AMP signal is delivered to the speaker by passing through the terminal PCB (910). Meanwhile, a lower surface unit (912) is attached to a lower surface of the first plate (902).

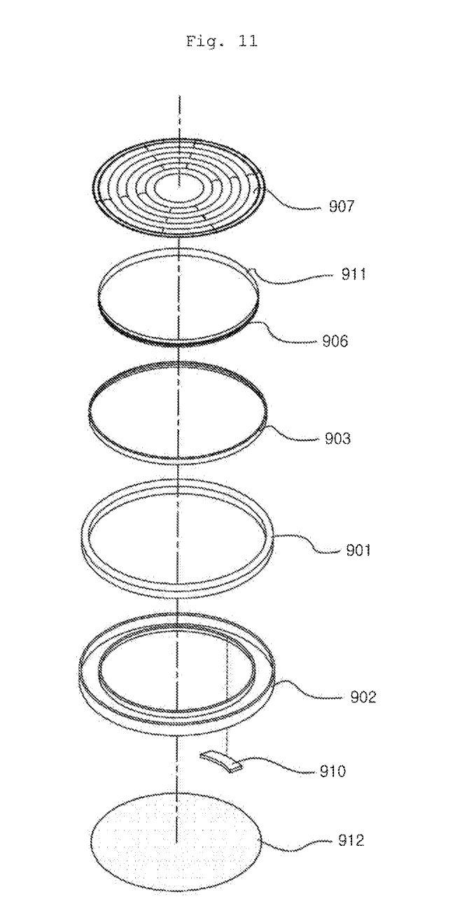

FIG. 10 illustrates a dispersed perspective view of a speaker according to the first embodiment of the present invention. The speaker shown in FIG. 10 corresponds to a case when the magnet (701) is configured to have a relatively rectangular ring shape.

As shown in FIG. 10, the magnet (701) is bound to an inner side surface of the first plate (702), and the second plate (703) having rectangular ring shape is bound to the inner side surface of the magnet (701). Meanwhile, the voice coil (706) is located in the magnetic gap, which corresponds to a gap formed. between the first plate (702) and the second plate (703). The inner surface of the voice coil (706) is connected to the diaphragm (707), which has a double dome structure, and the outer surface of the voice coil (706) is connected to the edge part, which configures the outer surface of the diaphragm.

Meanwhile, the terminal PCB (710), which is configured to supply the electrical signals, is located on the inner side surface of the first plate (702), and the upper portion and the lower portion of the speaker are respectively covered by the vent hole cap (711) and the lower surface part (712).

The speakers according to each exemplary embodiment of the present invention may be applied to diverse types of speakers. However, it is most particularly preferable that the speakers according to each exemplary embodiment of the present invention are applied to micro speakers.

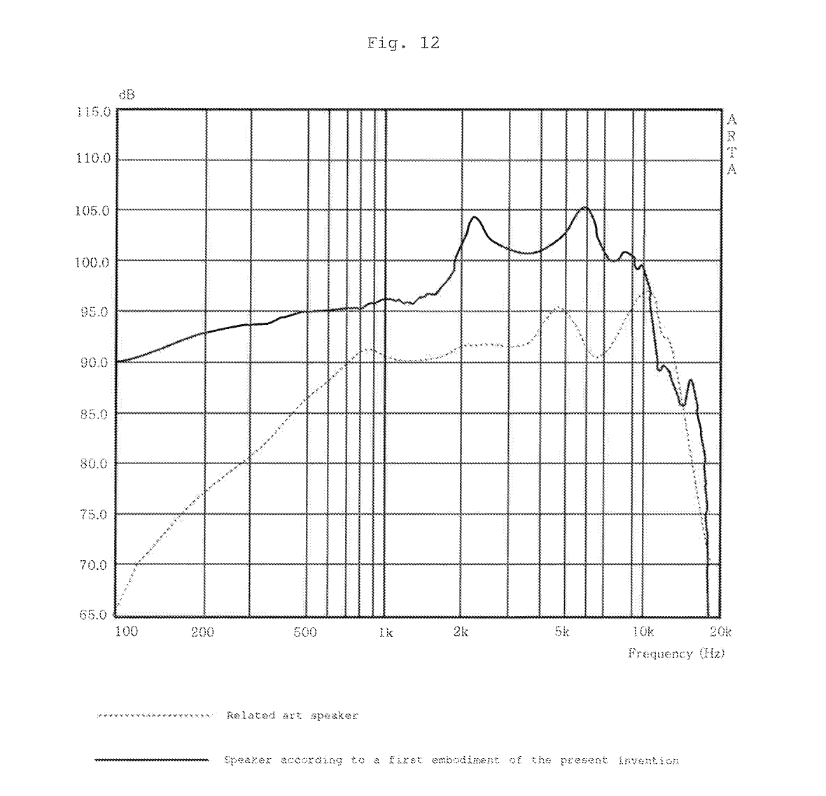

FIG. 11 illustrates a dispersed perspective view of a speaker according to the third embodiment of the present invention. The speaker shown in FIG. 11 corresponds to a case when the magnet (901) is configured to have a circular ring shape.

As shown in FIG. 11, the magnet (901) is fixed to an inner side surface of the first plate (902), and the second plate (903) having a circular ring shape is fixed to the inner side surface of the magnet (901). Meanwhile, the voice coil (906) is wound around the bobbin (911), and the bobbin (911) is located in the magnetic gap, which corresponds to an opening (or gap) formed between the first plate (902) and second plate (903).

Meanwhile, the inner surface of the bobbin (911) is connected to the diaphragm (907), which has a rib structure, and the outer surface of the bobbin (911) is connected to the edge part, which configures outer surface of the diaphragm (907).

Meanwhile, the terminal PCB (910), which is configured to supply the electrical signals, is located on the inner side surface of the first plate (902), and the lower portion of the speaker is covered by the lower surface part (912).

FIG. 12 illustrates a graph comparing a performance of the speaker according to the first embodiment of the present invention with a performance of the related art speaker. The graph of FIG. 12 shows the sound pressure and frequency according to a 3 cc open-back type by using an ARTA measurement device and a measurement microphone.

Referring to FIG. 12, it is apparent that, as compared to the related art speaker, the speaker according to the first embodiment of the present invention has a flatter characteristic in a frequency having a wide bandwidth. Additionally, in case of a middle frequency and a low frequency, which collectively correspond to the human voice frequency, the speaker according to the first embodiment of the present invention has a remarkably higher sound pressure. Accordingly, it is apparent that, when the present invention is applied to a mobile communication device, a high sound quality, which is equivalent to the sound quality provided through a pair of earphones, may be provided during a phone call.

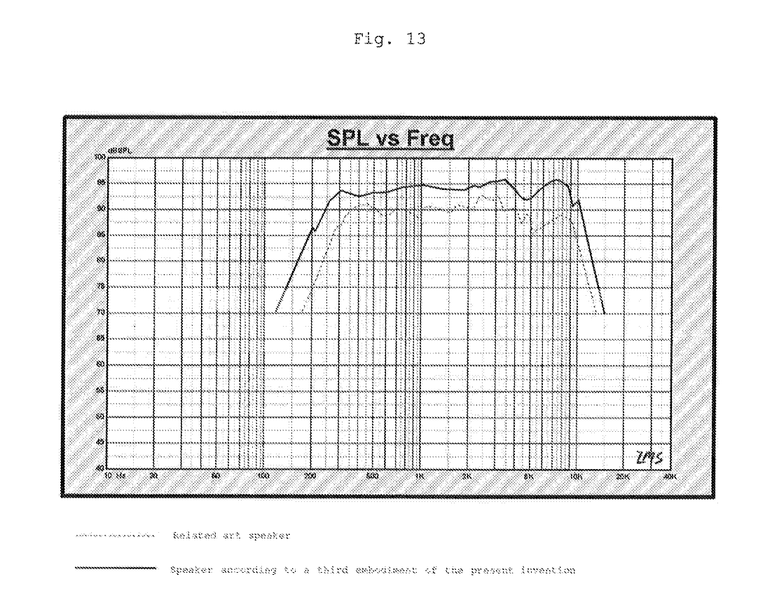

FIG. 13 illustrates a graph comparing a performance of the speaker according to the third embodiment of the present invention with a performance of the related art speaker. The graph of FIG. 13 shows the sound pressure and frequency at 1m/1v/2.83v in an 8 Ω standard by using an LMS measurement device and a measurement microphone.

Referring to FIG. 13, as compared to the related art speaker, the speaker according to the third embodiment of the present invention has a more excellent f0 of 200˜300 Hz and also has a higher sound pressure equal to or more than 4 dB.

The present invention described above, since replacement, modification and variation can be possible without departing from the scope of the inventions to one who skilled in the art, will not be limited only to the exemplary embodiments and the accompanying drawings that are presented herein.

### INDUSTRIAL APPLICABILITY

The present invention may be applied to various types of speakers.

What is claimed is:

1. A speaker, comprising:
a magnetic circuit and a vibration system, and
wherein the magnetic circuit comprises:
a magnetic circuit having a ring structure, having a first polarity on an outer side surface based upon a center point of the ring, and having a second polarity having an inner side surface, wherein the second polarity has a polarity opposite to that of the first polarity; and
a yoke providing a flow path for a magnetic flux being generated from the magnet.

2. The speaker of claim 1, wherein the yoke comprises:
first late providing a flow path for a magnetic flux corresponding to the first polarity; and
a second plate providing a flow path for a magnetic flux corresponding to the second polarity.

3. The speaker of claim 2, wherein the first plate and the second plate are spaced impart from one another, so as to create a magnetic gap.

4. The speaker of claim 1, wherein the yoke provides a flow path for a magnetic flux corresponding to the first polarity.

5. The speaker of claim 4, wherein the yoke and the magnet are spaced apart from one another, so as to create a magnetic gap.

6. The speaker of claim 1, wherein, based upon a center point of the ring, the vibration system is formed on an inside of the magnetic circuit.

7. The speaker of claim 6, wherein a height of the vibration system is lower than a height of the magnet.

8. The speaker of claim 1, wherein the vibration system comprises:
a voice coil functioning as a conducting wire through which electrical signals are supplied, being positioned within a magnetic field, the magnetic field being configured in accordance with the magnetic circuit, and performing mechanical movements in accordance with the electrical signals and the magnetic field; and
a diaphragm being connected to the voice coil and converting the mechanical movements of the voice coil to sound.

9. The speaker of claim 8, wherein the magnet has a step difference on the inner side surface based upon a center point of the ring.

10. The speaker of claim 9, wherein the vibration system further comprises:
an edge part having one side being connected to a step difference of the magnet, and having another side being connected to the voice coil.

11. The speaker of claim 1, wherein the ring structure corresponds to a circular ring structure.

12. The speaker of claim 1, wherein the ring structure corresponds to a rectangular ring structure.
